(19) United States
(12) Patent Application Publication
(10) Pub. No.: US 2025/0023274 A1
(43) Pub. Date: Jan. 16, 2025

(54) Combined Terminal for Charging

(71) Applicant: Li-Yin Huang, Dongguan City (CN)

(72) Inventor: Li-Yin Huang, Dongguan City (CN)

(21) Appl. No.: 18/351,500

(22) Filed: Jul. 13, 2023

(51) Int. Cl. H01R 13/187; B60L 53/16

(52) U.S. Cl. CPC H01R 13/187; B60L 53/16

(57) ABSTRACT

An improved combined terminal for charging, which includes a plug-in part, a wiring part, and a resilient conducting part. The resilient conducting part is limitedly installed between an upper conducting part and a lower conducting part. A twist-lock assembly is set between the plug-in part and the wiring part. The twist-lock assembly includes a sleeve. The upper conducting part and the lower conducting part are respectively sleeved at both ends of the sleeve and positioned by a positioning pin in the twist-lock assembly. The resilient conducting part generates pressing resilient deformation under the squeezing force of the upper conducting part and the lower conducting part to achieve conducting contact with the upper conducting part and the lower conducting part. The invention adopts the design of combining the plug-in part, the wiring part, and the twist-lock assembly, using the twist-lock assembly to realize the axial positioning of the plug-in part.

### TECHNICAL FIELD

This invention relates to the field of charging connector product technology, specifically referring to an improved combined terminal for charging.

### BACKGROUND ART

With the popularization of electric vehicles, the current charging gun presents the following problems: in the plug and socket of the charging gun, the conductive pin (post) and conductive terminal interface, due to long-term plugging and unplugging, friction and other situations, there will be wear and tear, and damage to the conductive pin (post), and conductive terminal. Serious damage may cause the charging gun to become unusable. Since the main parts of the current conductive pin (post) and conductive terminal are all integrated, even if there is only local wear or damage, it is necessary to replace the entire conductive pin (post) and conductive terminal.

To overcome this problem, a solution has been proposed, seen in Chinese patent number 201921160448.4, a utility model patent, which discloses a technical solution of a “detachable charging gun pin terminal and a charging gun equipped with the pin terminal”. In this technical solution, the conductive pin (post) used by the charging gun is no longer integrated, but formed by the combination of the terminal head and terminal tail connected by threads. In this way, only the terminal head, which is prone to wear and tear and damage issues, needs to be replaced, thus reducing maintenance costs.

The above technical solution still has room for improvement in terms of manufacturing and assembly process. Meanwhile, the threaded connection it uses has serious issues for current transmission, especially in large current charging operations like charging guns. The conductive contact of the threaded connection is prone to local high resistance leading to rapid heating and poor contact, among many other situations. Therefore, threaded connections are generally avoided in large current conductive contacts and elastic contact is usually used. In view of this, the inventor of this patent presents the following technical solution.

### SUMMARY

The purpose of this invention is to overcome the deficiencies in the existing technology, and to provide an improved combined terminal for charging, further reducing the cost of product maintenance and replacement.

To solve the aforementioned technical issues, the present case adopts the following technical solution:

An improved combination terminal for charging, comprising:
a plug-in part with a plug-in interface at a front end, and an upper conductive part formed integrally at a rear end;
a wiring part with a lower conductive part formed integrally at a front end corresponding to the upper conductive part, and a rear end connected to an external conductor;
a resilient conductive part positioned and installed between the upper and lower conductive parts,
a twist-lock assembly is provided between the plug-in part and the wiring part, the assembly includes a sleeve, the upper and lower conductive parts are respectively inserted into two ends of the sleeve, and are positioned through a positioning pin in the twist-lock assembly, the resilient conductive part undergoes compressive elastic deformation under the squeezing pressure of the upper and lower conductive parts to achieve conductive contact with the upper and lower conductive parts.

More preferably, wherein an inner wall of the plug-in interface forms a positioning groove, and a resilient conductive clip is limited in the positioning groove under the action of its own elastic expansion.

More preferably, wherein the upper conductive part is a platform formed at a rear end of the plug-in part, a bottom surface of the platform forms multiple points of resilient conductive contact with the resilient conductive part, and the bottom surface of the platform forms a convex point.

More preferably, wherein the lower conductive part includes: an upper platform formed at a front end of the wiring part and a receiving protruding edge located at an outer edge of the upper platform, the resilient conductive part forms a conductive contact with a side of the upper platform and/or the receiving protruding edge.

More preferably, wherein the resilient conductive part as a whole presents a dome shape with a notch, including: a non-closed annular base strip and a plurality of resilient arms formed integrally and distributed at intervals with the base strip; the resilient arms extend from the base strip towards the direction of the plug-in part, tilt towards an annular center circumscribed by the bottom, and then bend towards the center to make ends of the resilient arms point to the center;
under the squeezing pressure of the upper and lower conductive parts, the resilient conductive part undergoes elastic deformation as follows: a non-closed annular shape of the base strip expands outward under pressure, its outer surface is stretched and adheres to an inner wall of the sleeve of the twist-lock assembly, and a bottom of the base strip is pressed against the lower conductive part under the squeezing pressure; the resilient arms bend towards the center under pressure, causing a highest point of the resilient arms to be pressed on a bottom surface of the upper conductive part.

More preferably, wherein a gap is formed between the lower conductive part and the sleeve in the twist-lock assembly to accommodate the base strip.

More preferably, wherein a bottom of the base strip is serrated.

More preferably, wherein the twist-lock assembly includes a sleeve and a positioning pin, the positioning pin includes an upper positioning pin set on a side of the upper conductive part and a lower positioning pin set on a side of the lower conductive part;
an inner protruding edge corresponding to the upper positioning pin is formed on an upper inner edge of the sleeve, and the axial positioning between the plug-in part and the sleeve is achieved through the snap fit between the upper positioning pin and the inner protruding edge;
a positioning groove corresponding to the lower positioning pin is formed at a lower end of the sleeve, and the rotational direction positioning between the wiring part and the sleeve is achieved through the pinhole fit between the lower positioning pin and the positioning groove.

More preferably, wherein an inlet slot penetrating the inner protruding edge is opened along an upper end face of the sleeve, when the upper conductive part and the sleeve are inserted and fitted, the upper positioning pin located on a side of the upper conductive part first enters the inlet slot through axial movement, then rotates so that the upper positioning pin and the inlet slot are staggered, and the axial positioning between the plug-in part and the sleeve is achieved through the snap fit between the upper positioning pin and the inner protruding edge.

More preferably, wherein the positioning groove is opened along a lower end face of the sleeve, and the rotational direction positioning between the wiring part and the sleeve is achieved through the pinhole fit between the lower positioning pin and the positioning groove.

After adopting the aforementioned technical solution, the invention provides the following benefits:
1. The charging terminal of the invention is designed using a combination of a plug-in part, a wiring part, and a rotating buckle kit. The rotating buckle kit is used to achieve the axial positioning of the plug-in part. This way, there is no need to further use the plastic base of the charging gun to position the plug-in part. When replacing the plug-in part, it is only necessary to separate the plug-in part from the rotating buckle kit and remove it from the charging gun. There is no need to disassemble the charging gun, making the replacement more convenient and faster.
2. The charging terminal of the invention uses a combination design of a plug-in part, a wiring part, and a rotating buckle kit. Each component is simpler to manufacture, which can further improve production efficiency and reduce production costs. Meanwhile, assembly is also simpler and more convenient.
3. In the invention, multiple points of elastic conductive contact are formed between the elastic conductive part and the upper conductive part, which can adapt to the large current charging operation of the charging gun. The plug-in part and the wiring part are interconnected through the elastic conductive part, which can ensure the stability of the connection.

The elastic connection part of the invention uses an expansion and compression structure, which does not require a long elastic compression space, and achieves stable elastic support within a short distance, thereby ensuring the stability of the conductive contact.

### BRIEF DESCRIPTION OF THE DRAWINGS

FIG. 1 is a three-dimensional view of the invention;

FIG. 2 is a three-dimensional view of the invention from another perspective;

FIG. 3 is an exploded three-dimensional view of the invention;

FIG. 4 is a cross-sectional view along line A-A in FIG. 1;

FIG. 5 is a cross-sectional view along line B-B in FIG. 1;

FIG. 6 is a schematic diagram of the assembly process in the invention;

FIG. 7 is a three-dimensional view of the plug-in part in the invention;

FIG. 8 is a three-dimensional view of the sleeve in the invention;

FIG. 9 is a three-dimensional view of the elastic conductive part in the invention;

FIG. 10 is an enlarged view of section C in FIG. 4;

FIG. 11 is a three-dimensional view of the invention when used in a charging gun.

### DETAILED DESCRIPTION OF THE EMBODIMENTS

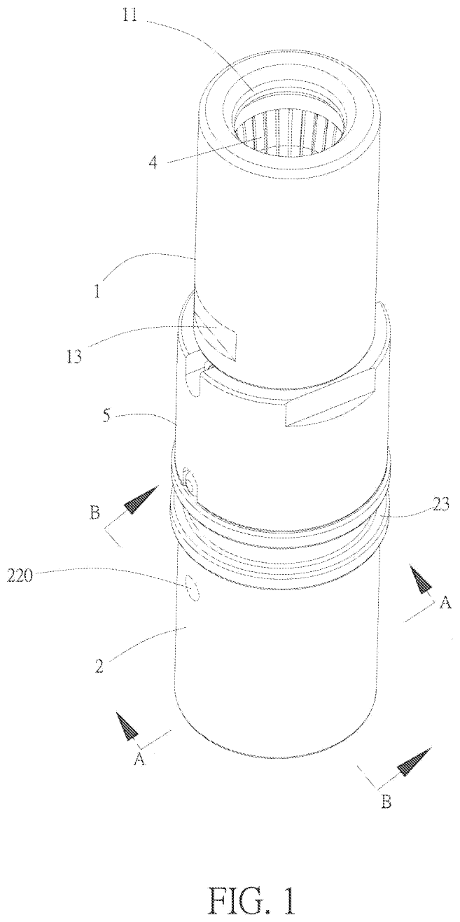

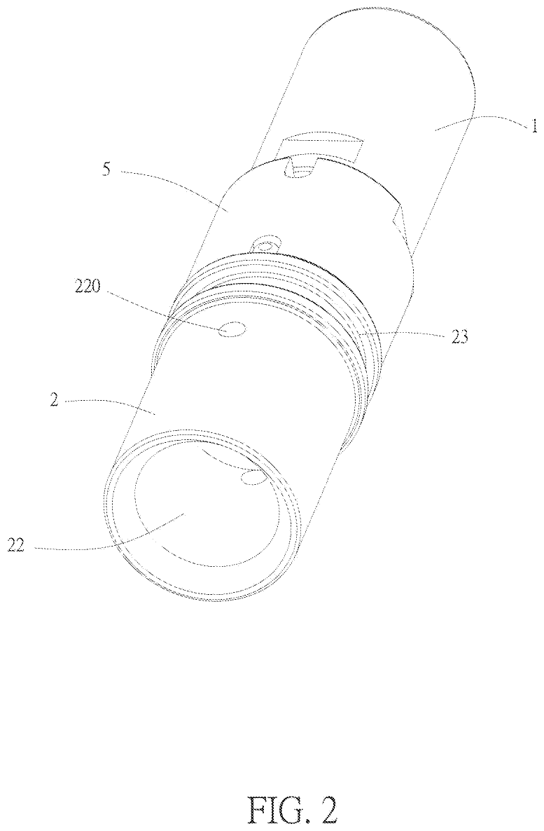

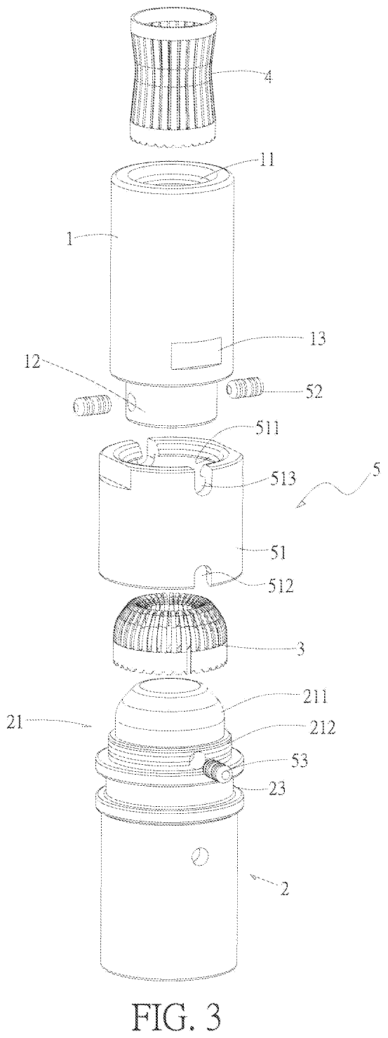

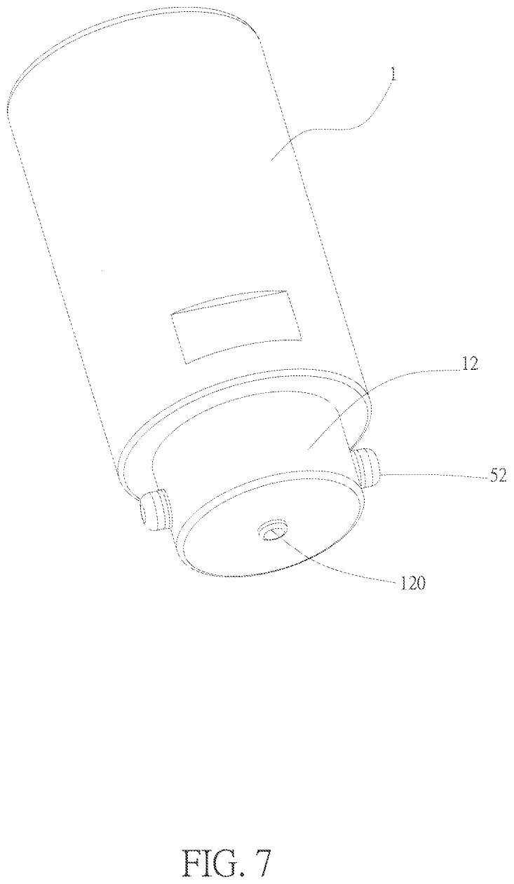

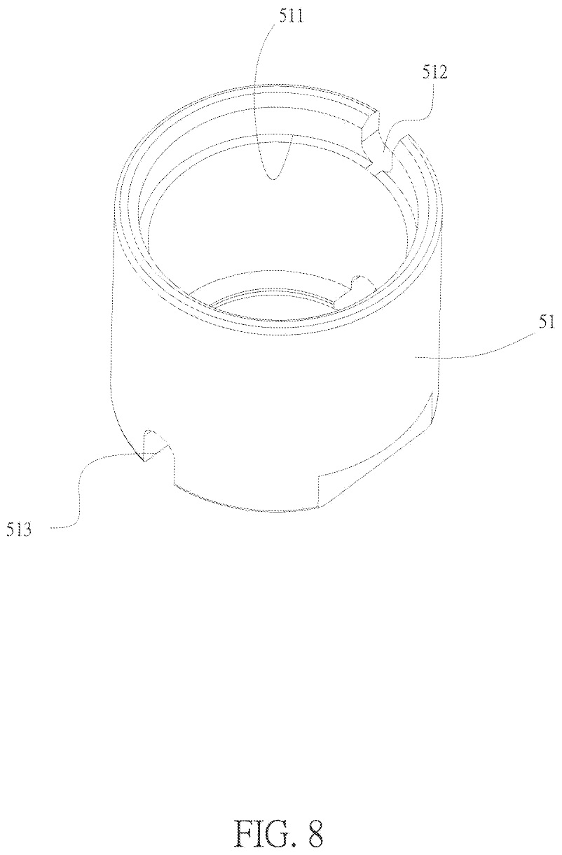

As shown in FIGS. 1 to 9, this is an improved charging terminal assembly, which includes: a plug-in part 1, a wiring part 2, a resilient conductive part 3, a resilient conductive clip 4, and a twist-lock assembly 5.

The plug-in part 1 is used for docking with an external conductive pin (post), so a plug-in interface 11 is set up at a front end of the plug-in part 1. The external conductive pin (post) is inserted into the plug-in interface 11 during the docking process. To ensure stable high-current conduction between the plug-in interface 11 and the conductive pin (post), a resilient conductive clip 4 is installed in the plug-in interface 11. Specifically, the resilient conductive clip 4 is an open loop. A positioning slot 111 is formed on an inner wall of the plug-in interface 11, and the resilient conductive clip 4 is limited to the positioning slot 111 under its own elastic expansion effect.

The rear end of the plug-in part 1 is equipped with an upper conductive part 12. In this embodiment, the upper conductive part 12 is a pedestal formed at the rear end of the plug-in part 1. The bottom surface of the pedestal will form a resilient conductive contact with the resilient conductive part 3.

The plug-in part 1 is a cylinder. For the convenience of positioning and restriction during rotation, a first positioning part 13 is formed on the circumferential surface of the plug-in part 1.

The wiring part 2 is used for external wire connection. The wiring part 2 is usually fixed in the plastic base of the charging gun by a one-piece molding method. Its front end is equipped with a lower conductive part 21 corresponding to the upper conductive part 12. The rear end of the wiring part 2 has a connection hole 22 for connecting with external wires.

The lower conductive part 21 includes an upper protrusion 211 formed at the front end of the wiring part 2 and a receiving protruding edge 212 located along the edge of the upper protrusion 211.

The resilient conductive part forms a conductive contact with the side of the upper protrusion and/or the receiving protruding edge.

A positioning groove 23 is formed on the circumferential surface of the wiring part 2. During the assembly process of the charging gun, it will be matched with the external plastic base through the positioning groove 23 to fix the wiring part 2 to the plastic base. Additionally, a through hole 220 communicating with the connection hole 22 is opened in the wiring part 2. The through hole 220 can form a vent hole during the plug-in cooperation, which is beneficial for plug-in.

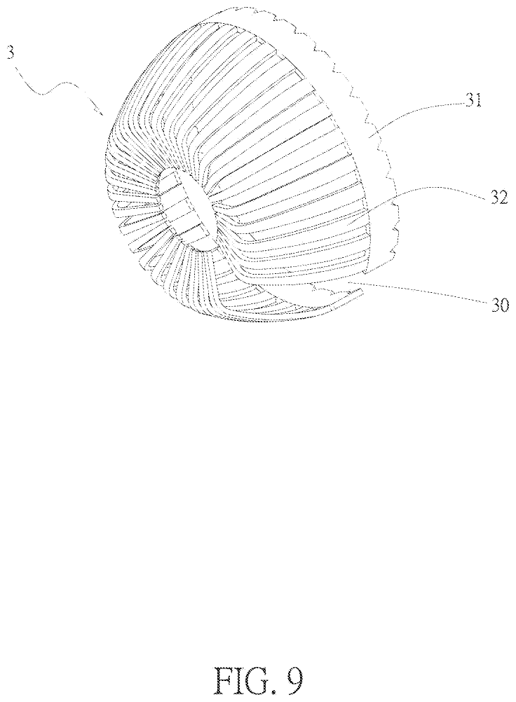

The resilient conductive part 3 is limit-positioned and installed between the upper conductive part 12 and the lower conductive part 21. As shown in FIG. 9, the resilient conductive part 3 is overall a dome shape with a notch 30, which includes: a non-closed annular base strip 31 and a plurality of resilient arms 32 integrally formed with the base strip 31 and distributed at intervals. The resilient arms 32 extend from the base strip 31 towards the direction of the plug-in part 1, and while extending, they incline towards the ring center surrounded by the bottom 31, then by bending towards the center direction, the ends of the resilient arms 32 point towards the center direction. The bottom of the base strip 31 is saw-toothed.

The twist-lock assembly 5 is set between the plug-in part 1 and the wiring part 2, which includes: a sleeve 51 and a positioning pin. The positioning pin includes: an upper positioning pin 52 set on the side of the upper conductive part and a lower positioning pin 53 set on the side of the lower conductive part 21. The upper conductive part 12 and the lower conductive part 21 are respectively inserted into the two ends of the sleeve 51, and they are positioned through the positioning pin in the twist-lock assembly 5. Under the extrusion pressure of the upper conductive part 12 and the lower conductive part 21, the resilient conductive part 3 undergoes compressive elastic deformation, realizing conductive contact with the upper conductive part 12 and the lower conductive part 21. Specifically, the inner edge of the upper end of the sleeve 51 forms an inner protruding edge 511 that matches the upper positioning pin 52. The upper positioning pin 52 is inserted and fixed into the small hole opened on the circumferential surface of the upper conductive part 12. To maintain stable positioning, two upper positioning pins 52 are evenly set on the upper conductive part 12. Through the buckle cooperation between the upper positioning pin 52 and the inner protruding edge 511, the axial positioning between the plug-in part and the sleeve 51 is realized. The lower end of the sleeve 51 forms a positioning slot 512 that matches the lower positioning pin 53. Through the hole cooperation between the lower positioning pin 53 and the positioning slot 512, the rotation direction positioning between the wiring part 2 and the sleeve 51 is realized.

To achieve the docking of the upper conductive part 12 and the sleeve 51, an inlet slot 513 that penetrates the inner protruding edge 511 is opened along the upper end face of the sleeve 51. When the upper conductive part is inserted and matched with the sleeve 51, the upper positioning pin 52 on the side of the upper conductive part first enters the inlet slot 513 through axial movement, and then intersects with the inlet slot 513 by rotation. The axial positioning between the plug-in part and the sleeve 51 is realized through the buckle cooperation between the upper positioning pin 52 and the inner protruding edge 511.

The positioning slot 512 is opened along the lower end face of the sleeve 51. The rotation direction positioning between the wiring part 2 and the sleeve 51 is realized through the pin hole cooperation between the lower positioning pin 53 and the positioning slot 512.

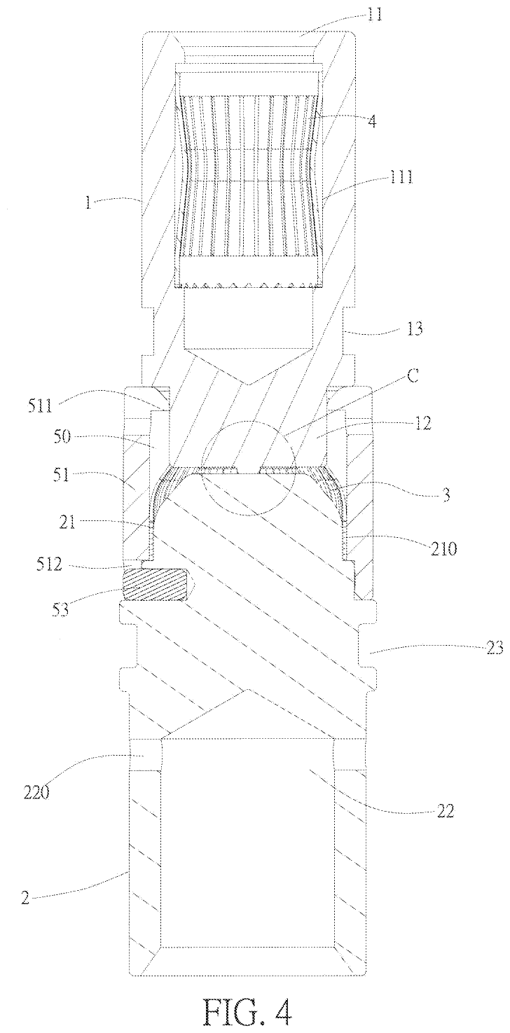

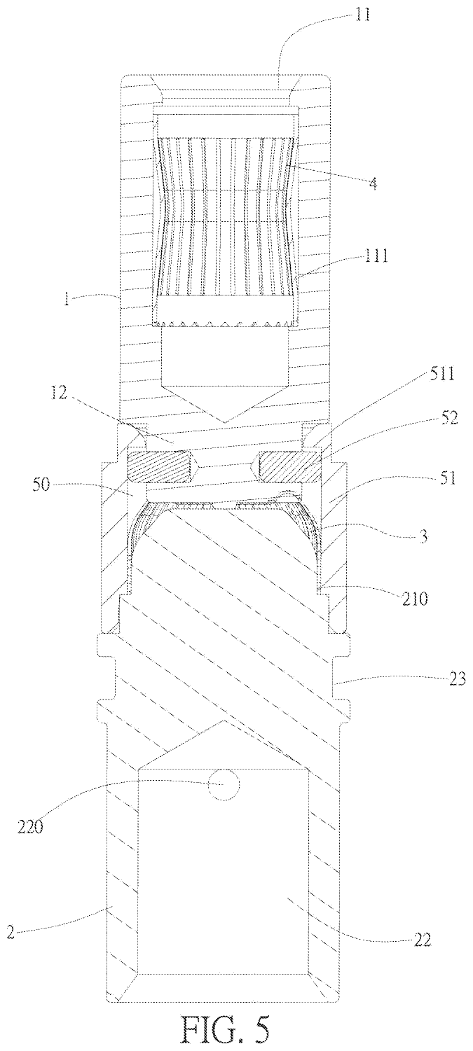

As shown in FIGS. 4 and 5, when the twist-lock assembly 5 is connected and matched with the plug-in part 1 and the wiring part 2, the bottom surface of the plug-in part 1 presses against the upper end surface of the sleeve 51, and the lower end surface of the sleeve 51 presses against the receiving protruding edge 212 of the lower conductive part 21. A cavity 50 is formed between the sleeve 51 and the lower conductive part 21. This cavity 50 is used to accommodate the resilient conductive part 3. A gap 210 for accommodating the bottom strip is formed between the upper protrusion 211 in the lower conductive part 21 and the sleeve 51 in the twist-lock assembly 5.

During the assembly of the resilient conductive part 3, the resilient conductive part 3 is compressed towards its center using its notch 30, so that the diameter of the entire shape surrounded by the resilient conductive part 3 is reduced and it can be placed into the cavity 50 through the upper port of the sleeve 51. When the resilient conductive part 3 is placed inside the cavity 50, the external force acting on it disappears, and under its own elasticity, the entire resilient conductive part 3 expands towards the periphery and returns to its original position under the restriction of the sleeve 51. The base strip 31 is inserted into the gap 210.

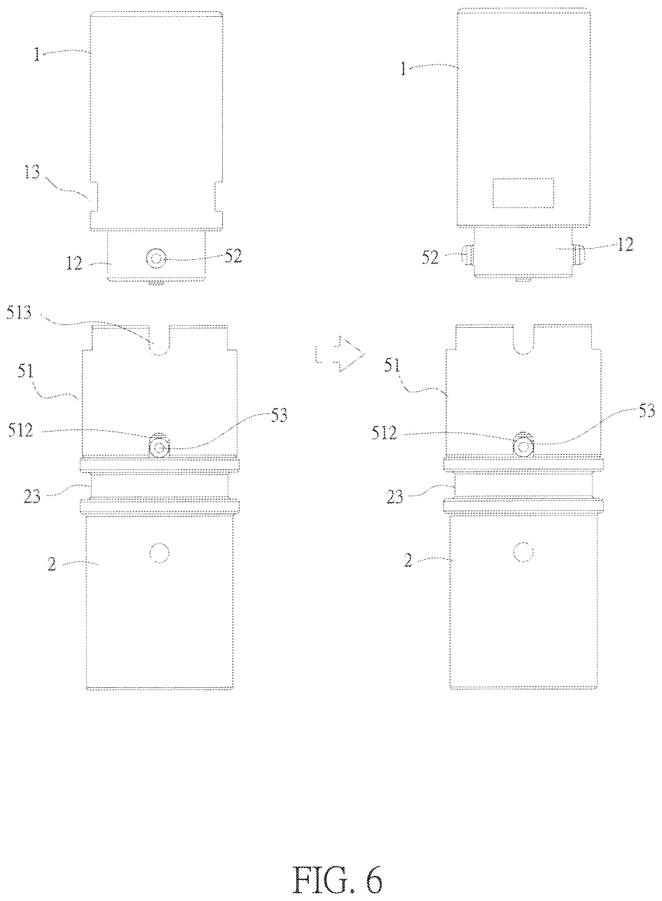

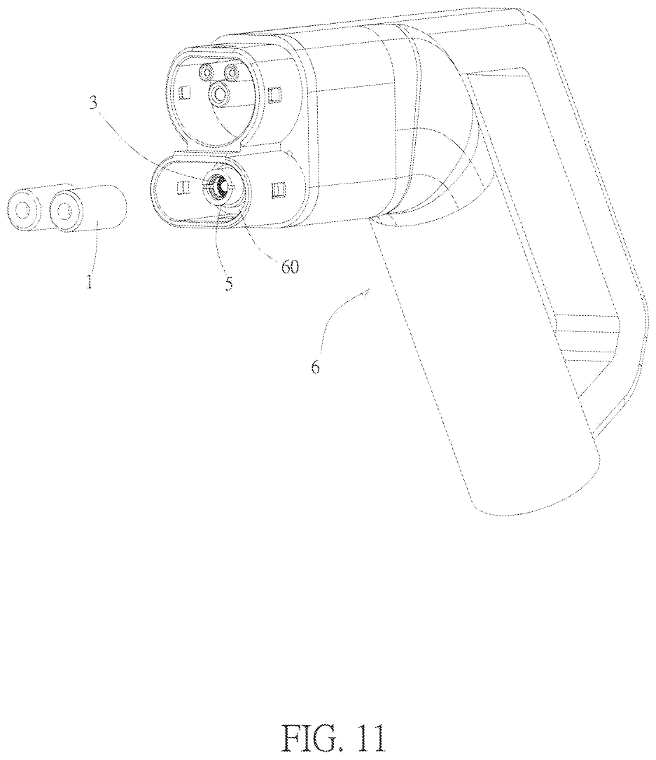

As shown in FIG. 11, this is a three-dimensional diagram of the case used in the charging gun 6. After the wiring part 2 and the sleeve 51 in the twist-lock assembly 5 are assembled, they are fixed or integrally injection molded in the plastic base 60 of the charging gun 6. Then, the plug-in part 1 is matched with the sleeve 51. As shown in FIG. 6, when installing the plug-in part 1, the upper positioning pin 52 on the plug-in part 1 first moves axially into the inlet slot 513 through the inlet slot 513, and then after rotating by a certain angle (shown as 90 degrees in the FIG.), it makes the upper positioning pin 52 intersect with the inlet slot 513. The axial positioning between the plug-in part and the sleeve 51 is realized through the buckle cooperation between the upper positioning pin 52 and the inner protruding edge 511.

On the contrary, when it is necessary to replace the plug-in part 1, you only need to rotate the plug-in part 1 by a certain angle, so that the upper positioning pin 52 on the plug-in part 1 aligns with the inlet slot 513, and then you can remove the plug-in part 1.

The conduction principle of the resilient conductive part 3 in the invention is as follows:

First, when the plug-in part 1 is inserted and matched with the sleeve 51, the upper conductive part 12 will generate downward pressure on the resilient conductive part 3. The resilient conductive part 3 is subjected to elastic deformation due to the squeezing pressure of the upper conductive part 12 and the lower conductive part 21:
(1) Under pressure, the non-closed ring formed by the base strip 31 expands outward, its outer surface is inflated and adheres to the inner wall of the sleeve 51, and under pressure, the base strip 31 is inserted into the gap 210, forming a conductive contact surface between the base strip 31 and the peripheral surface of the upper convex platform.
(2) The bottom of the base strip 31 is pressed against the surface of the receiving protruding edge 212 under pressure. At the same time, the bottom of the base strip 31 is serrated or similar to a serrated shape. This can ensure that there are multiple points of conductive contact.
(3) Under pressure, the flexible arm 32 bends towards the center, causing the highest point of the flexible arm 32 to press against the bottom surface of the platform that forms the upper conductive part 12. Since there are multiple resilient arms 32 in the entire resilient conductive part 3, under pressure, each flexible arm 32 can achieve conductive contact with the bottom surface of the platform of the upper conductive part 12. These resilient arms 32 form multiple parallel paths, which not only ensures stable conductive contact but also facilitates high current charging operations.

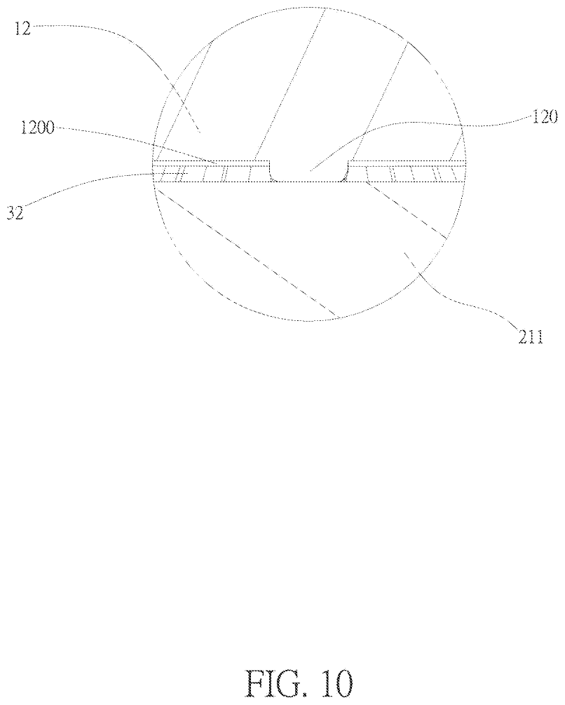

In addition, as shown in FIG. 4, when the plug-in part 1 is connected and matched with the wiring part 2 through the twist-lock assembly 5, the flexible arm 32 of the resilient conductive part 3 will deform under the clamping of the upper conductive part 12 and the lower conductive part 21, thereby achieving stable elastic conductive contact. If the gap between the bottom surface of the upper conductive part 12 and the top surface of the lower conductive part 21 is too small, it will cause the flexible arm 32 between the bottom surface of the upper conductive part 12 and the top surface of the lower conductive part 21 to be completely flattened. This will not only cause the flexible arm 32 to deform completely and be difficult to reset, but also because there is no gap between the upper conductive part 12 and the lower conductive part 21, it will cause a “jam” situation when the plug-in part 1 is screwed in or out of the twist-lock assembly 5, making it difficult to replace the damaged plug-in part 1. Therefore, to solve this problem, as shown in FIG. 10, a convex point 120 is formed on the bottom surface of the platform as the upper conductive part 12, and the height of the convex point 120 is greater than the thickness of the flexible arm 32. So when the plug-in part 1 and the wiring part 2 are connected and matched, a gap 1200 larger than the thickness of the flexible arm 32 is formed between the bottom surface of the upper conductive part 12 and the top surface of the lower conductive part 21, to facilitate subsequent replacement of the plug-in part 1.

Of course, the above descriptions are just specific implementations of the invention and do not limit the scope of the case's implementation. Any equivalent changes or modifications made according to the structure, characteristics, and principles described in the patent application range of the invention should be included in the patent application range of the invention.

I claim:

1. An improved combination terminal for charging, comprising:
a plug-in part with a plug-in interface at a front end, and an upper conductive part formed integrally at a rear end;
a wiring part with a lower conductive part formed integrally at a front end corresponding to the upper conductive part, and a rear end connected to an external conductor;
a resilient conductive part positioned and installed between the upper and lower conductive parts,
a twist-lock assembly positioned between the plug-in part and the wiring part, the twist-lock assembly including a sleeve, the upper and lower conductive parts respectively inserted into two ends of the sleeve, positioning achieved through a positioning pin in the twist-lock assembly, with the resilient conductive part undergoing compressive elastic deformation under the squeezing pressure of the upper and lower conductive parts to ensure conductive contact with the upper and lower conductive parts.

2. The improved combination terminal for charging according to claim 1, wherein an inner wall of the plug-in interface forms a positioning slot, and a resilient conductive clip is limited in the positioning slot under the action of the elastic expansion of the resilient conductive clip.

3. The improved combination terminal for charging according to claim 1, wherein the upper conductive part is a platform formed at a rear end of the plug-in part, a bottom surface of the platform forms multiple points of resilient conductive contact with the resilient conductive part, and the bottom surface of the platform forms a convex point.

4. The improved combination terminal for charging according to claim 1, wherein the lower conductive part includes an upper protrusion formed at a front end of the wiring part and a receiving protruding edge located at an outer edge of the upper protrusion, the resilient conductive part forms a conductive contact with a side of the upper protrusion and/or the receiving protruding edge.

5. The improved combination terminal for charging according to claim 1, wherein the resilient conductive part as a whole presents a dome shape with a notch, including a non-closed annular base strip and a plurality of resilient arms formed integrally and distributed at intervals with the base strip; the resilient arms extend from the base strip towards the direction of the plug-in part, tilt towards an annular center circumscribed by the bottom, and then bend towards the center to make ends of the resilient arms point to the center;
under the squeezing pressure of the upper and lower conductive parts, the resilient conductive part undergoes elastic deformation as follows: a non-closed annular shape of the base strip expands outward under pressure, its outer surface is stretched and adheres to an inner wall of the sleeve of the twist-lock assembly, and a bottom of the base strip is pressed against the lower conductive part under the squeezing pressure; the resilient arms bend towards the center under pressure, causing a highest point of the resilient arms to be pressed on a bottom surface of the upper conductive part.

6. The improved combination terminal for charging according to claim 5, wherein a gap is formed between the lower conductive part and the sleeve in the twist-lock assembly to accommodate the base strip.

7. The improved combination terminal for charging according to claim 5, wherein a bottom of the base strip is serrated.

8. The improved combination terminal for charging according to claim 1, wherein the twist-lock assembly includes a sleeve and a positioning pin, the positioning pin includes an upper positioning pin set on a side of the upper conductive part and a lower positioning pin set on a side of the lower conductive part;
an inner protruding edge corresponding to the upper positioning pin is formed on an upper inner edge of the sleeve, and the axial positioning between the plug-in part and the sleeve is achieved through the snap fit between the upper positioning pin and the inner protruding edge;
a positioning slot corresponding to the lower positioning pin is formed at a lower end of the sleeve, and the rotational direction positioning between the wiring part and the sleeve is achieved through the pinhole fit between the lower positioning pin and the positioning slot.

9. The improved combination terminal for charging according to claim 8, wherein an inlet slot penetrating the inner protruding edge is opened along an upper end face of the sleeve, when the upper conductive part and the sleeve are inserted and fitted, the upper positioning pin located on a side of the upper conductive part first enters the inlet slot through axial movement, then rotates so that the upper positioning pin and the inlet slot are staggered, and the axial positioning between the plug-in part and the sleeve is achieved through the snap fit between the upper positioning pin and the inner protruding edge.

10. The improved combination terminal for charging according to claim 8, wherein the positioning slot is opened along a lower end face of the sleeve, and the rotational direction positioning between the wiring part and the sleeve is achieved through the pinhole fit between the lower positioning pin and the positioning slot.
